(19) United States
(12) Patent Application Publication
(10) Pub. No.: US 2009/0260024 A1
(43) Pub. Date: Oct. 15, 2009

(54) Process Information Management System

(75) Inventors: Keith L. Dera, Herndon, VA (US); Alan R. Emerson, Columbus, OH (US)

Correspondence Address: BAKER BOTTS LLP, 2001 ROSS AVENUE, 6TH FLOOR, DALLAS, TX, 75201-2980, US

(73) Assignee: Raytheon Company, Waltham, MA (US)

(21) Appl. No.: 12/103,579

(22) Filed: Apr. 15, 2008

(51) Int. Cl. G06F 9/44; G06F 3/048

(52) U.S. Cl. 719/331; 715/762

(57) ABSTRACT

An information management system is provided. The information management system includes a common process portal, which may, in one example architecture, be provided as a web-based application. The portal includes a variety of modules to enable housing of information such as process documentation. The portal also provides for the seamless and automatic referencing of the information and exporting of information to one or more additional applications using the information. One or more reference identifiers may be used to automatically link a data element to one or more pre-determined, selectable modules of the common process portal.

### TECHNICAL FIELD

This invention relates generally to information management systems and, more particularly, to platforms for managing process documentation across multiple parts of an enterprise and across multiple information systems.

### BACKGROUND

Businesses commonly employ systems and software to improve their processes. Such systems and software vary greatly, as do the business processes themselves. An example of a known system for managing information process is Capability Maturity Model Integration (CMMI®). CMMI® is a process improvement approach aimed at providing organizations with the basic elements for process management. Among other things, CMMI® helps integrate separate organizational functions. Information regarding CMMI® may be found on the Internet at www.sei.cmu.edu/cmmi. CMMI® is sponsored by the U.S. Department of Defense and the National Defense Industrial Association, and was developed with input from industry, government, and the Software Engineering Institute. CMMI® represents a standard industry model for process documentation.

There are also off-the-shelf systems for managing process documentation. One known example is APPRAISAL WIZARD® which is available from a company called Integrated System Diagnostics. Information regarding APPRAISAL WIZARD® may be found on the Internet at www.isd-inc.com/.

### SUMMARY

Enterprises commonly have either or both of proprietary systems or off-the-shelf systems to manage their process documentation. There is a difficulty that arises in having both proprietary systems and off-the-shelf systems, or in having more than one process management system. One such difficulty is that the systems are generally not compatible with respect to how documents are managed within the respective systems. A related difficulty is that data entry in connection with various process documents must be repeated for entry of those documents into each of the respective process document management systems.

Among other things, an example of the present invention provides a system for managing a plurality of information elements. The system includes at least one processor operable to execute a plurality of software modules and at least one data storage device coupled to the at least one processor. The at least one data storage device is operable to store data and transfer data to and from the at least one processor. The plurality of software modules include a plurality of application modules operable to process the information elements and a common module in communication with the plurality of application modules. The common module includes an information storage component for effecting storage of the information elements and a referencing component operable to automatically associate each of the information elements with one or more selected application modules.

Certain embodiments of the present invention may provide some, none, or all of the following advantages. One advantage of at least one embodiment is that a system is provided which can avoid replication of data entry tasks associated with managing data in two different information systems. Another advantage is that data output from one information management system is automatically compatible with the requirements for one or more other information management systems. Another advantage is that data elements may be housed, referenced and exported automatically and seamlessly between information systems and between modules and/or applications within an information management system. This can be accomplished without replicating the data or migrating the information, by a separate, additional process, from one application to another. Various embodiments of the invention may provide some, none, or all of the foregoing advantages, or may provide additional advantages.

### BRIEF DESCRIPTION OF THE DRAWINGS

FIG. 1 is an information network according to an example embodiment of the present invention;

FIG. 2 is a diagram representing a process management structure for an enterprise according to an example embodiment of the present invention;

FIG. 3 is a block diagram representing a variety of modules for a common process portal according to an example embodiment of the present invention;

FIGS. 4A-4C are diagrams illustrating certain functionality associated with an embodiment of the present invention; and

FIGS. 5A-5G are illustrations of graphical user interfaces in accordance with example embodiments of the present invention.

### DETAILED DESCRIPTION

Among other things, the present invention provides a common process portal which may be used to store, process and display information in connection with an enterprise information system. Although the portal will be described, in certain examples, in terms of coordinating process documentation in a CMMI® environment, and coordinating proprietary and off-the-shelf process document management systems, it should be understood that the portal and its various functionalities may be used to manage information assets in any suitable environment. Thus, the invention is by no means limited to the CMMI® environment, or to any particular proprietary and/or off-the-shelf process document management system. Nor is the invention limited to process documentation systems. Rather, aspects of the invention may be applied to any number of information management systems.

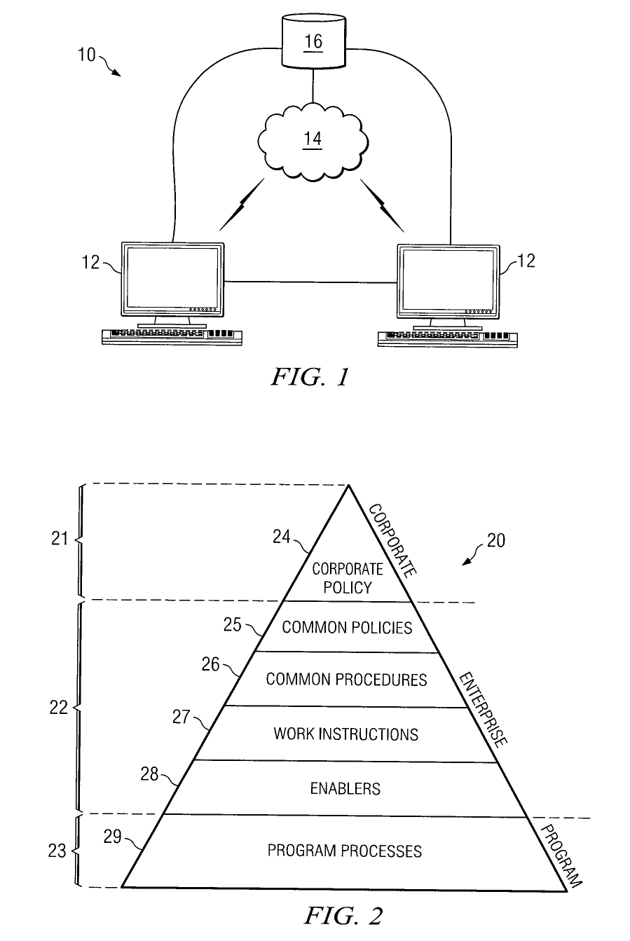

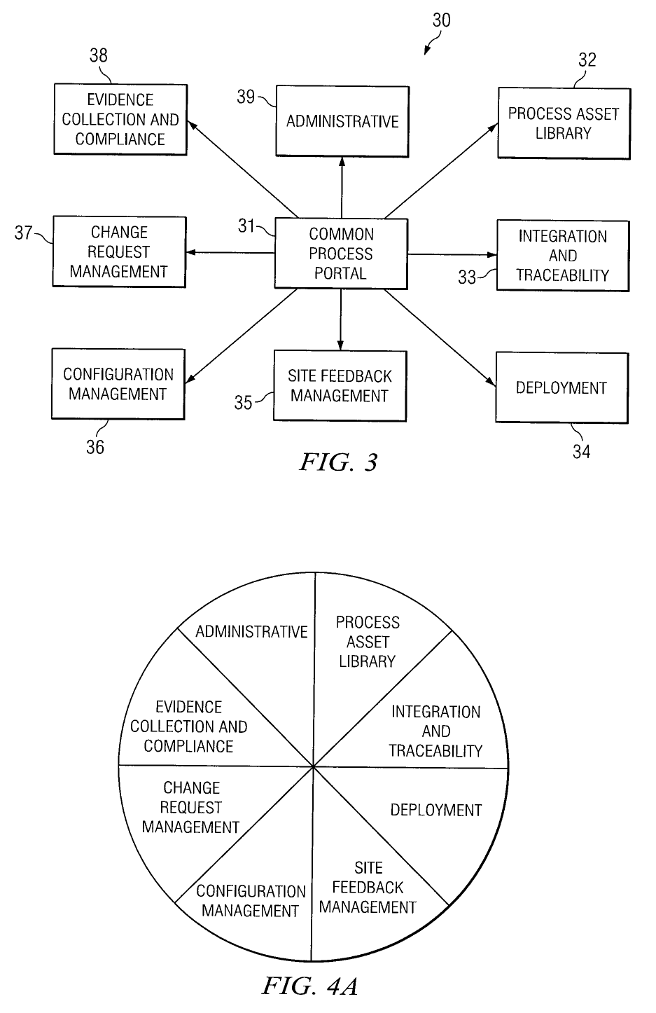

An example embodiment of a common process portal, and certain modules thereof is illustrated, for example, in FIG. 3. This example will be discussed in further detail below. The common process portal and its various modules may be implemented in any suitable information network, such as the computer network illustrated in FIG. 1. The information system 10 may comprise a plurality of computers 12. Computers 12 may be linked directly together and/or linked together through a communications network 14. The system 10 may further comprise one or more repositories 16 which may be linked to computers 12, either directly or through communications network 14.

The system will be described in terms of enterprise applications or modules. However, the inventive aspects described herein are not limited to enterprise applications. For instance, other sources of data may be incorporated into various described embodiments. Such sources may include, for example, any computer application, database, program, etc. Data files may include data in any format including, for example, static, dynamic HTML, XML, graphics, multimedia, and traditional document files. Generally, the term computer application may be used to refer to the various sources of information being searched, and data file may be used to refer to information in the various sources.

The networks used in the system, or in connection with the system, may comprise any suitable network or combination of networks. Information transmitted across a network may include any information, in any format, which is necessary or desirable in the operation of the system. The information may be transmitted in whole, or in combination, in any format including digital or analog, text or voice, and according to any known or future transport technologies, which may include, for example, wireline or wireless technologies. Wireless technologies may include, for example, licensed or license-exempt technologies. Some specific technologies which may be used include, without limitation, Code Division Multiple Access (CDMA), Global System for Mobile Communication (GSM), General Packet Radio Service (GPRS), WiFi (802.11x), WiMax (802.16x), Public Switched Telephone Network (PSTN), Digital Subscriber Line (DSL), Integrated Services Digital Network (ISDN), cable modem, Ethernet, and/or EV-DO technologies. The network may also comprise Internet transport. These are examples only and one of ordinary skill will understand that other types of communication techniques are within the scope of the present invention. Further, it will be understood that additional components may be used in the communication of information between the various components of the system and users of the system. Such additional components may include, without limitation, lines, trunks, antennas, switches, cables, transmitters, receivers, computers, routers, servers, fiber optical transmission equipment, repeaters, amplifiers, etc.

The system may include various displays, processors, databases, modules, etc. These various components may be embodied in any suitable hardware and/or software devices, which are operable to provide the various functionalities described in connection with the example embodiments.

In order to better understand the functionality of the common process portal, it is helpful to first understand an example common process architecture for an enterprise. An example architecture is illustrated in FIG. 2. The architecture may be viewed as a hierarchy 20 including a corporate component 21, an enterprise component 22, and a program component 23. In the illustrated example, corporate component 21 includes a single element 24 which is the corporate policy. In other process architectures, the corporate component may include additional elements having applicability across an enterprise. In general, the corporate component may be viewed as that set of rules which will ultimately apply to all process components and documentation which are generated to support programs in the program component. Enterprise component 22 is illustrated as including a common policies element 25, a common procedure element 26, a work instructions element 27, and an enablers element 28. In other architectures, the enterprise component may include different and/or additional or fewer elements. Program component 23 is illustrated as including a single element 29, which is the program processes element. Again, in other architectures, the program component may include additional elements.

Process documentation may be generated, for example, by way of the various process elements included in the enterprise component. For instance, the common policies element 25 may include documentation that specifies operating principles and standards by which the business is guided. These documents may communicate direction and philosophy to accomplish overall business objectives and may be based, for example, on customer, statutory, and regulatory requirements. The common procedures element, for example, may include documentation that specifies, at high level, which activities are to be performed. The documentation may also specify when, where, and why those activities are to be performed. Further, documentation generated in connection with this element may specify who is functionally responsible to perform the activities. This may include necessary inputs, required tasks, and expected outputs (e.g., work product). Work instructions element 27 may generate documentation which specifies detailed specific implementation activities to be performed. The level of detail may be that deemed necessary by the process owner, and based upon task complexity, methods used, skills and training. Work instructions from this element are preferably tied to procedures from the common procedures element. The enablers element 28 may include a variety of tools to assist the user or process owner in generating a set of documents necessary to support a particular program. Examples of these tools may include templates, product standards, guidance audit checklists, forms, training materials, manuals, tools, and local-site unique enablers.

One example embodiment of a common process portal 31 is illustrated in FIG. 3. Portal 31 includes and/or interacts with a number of functional modules. The functional modules may comprise, for example, process asset library 32, integration and traceability module 33, deployment module 34, site feedback management module 35, configuration management module 36, change request management module 37, evidence collection and compliance module 38, and administrative module 39. Thus, in one example, the common process portal 31 may be viewed as a suite of functional elements which may be used in various combinations to align a particular data element with a given piece of process information. The data element may be, for example, a document such as a web-based process document. In one embodiment, the common process portal facilitates using a proprietary information system together with an off-the-shelf information system. Information management data entry in connection with the various data elements being managed may be conducted a single time. Such information management data entry may include a variety of inputs such as document title, document description, document ID, and so forth. The common process portal preferably provides the proprietary system with an output port for information management data in a form acceptable to a third party off-the-shelf system.

In one example embodiment, the common process portal is a web-based application designed to store, process, and display information relating to common process assets within an enterprise. While the common process portal is described as being a web-based application in this example, it should be understood that the portal may reside in any suitable information management architecture.

The portal application may provide one or more graphical user interfaces which may comprise one or more pages. The portal application may include a home page to serve as a site map and also link to training materials and various other operational documents. In one example, the remaining pages of the portal are grouped by functional areas. The main functional areas preferably correspond to the various modules of the portal and may include, for example, CPP system administration, configuration management (CM), evidence collection and compliance (ECC), integration and traceability (IT), process asset library (PAL), process deployment, feedback management, and change request management. Pages for each functional area may be contained in their respective CPP subfolder.

Global images, “includes,” and “iframes” that are used by the CPP home page, and/or pages in multiple functional areas, may be contained in their appropriate top-level global folders. Functional-specific images, includes and iframes may be contained in their respective subfolders in the functional area folders. Pages within the CPP application may include a number of common components that make up their header, footer, and navigation areas. These may include, for example, a common header with links to an enterprise information system, a common “find a person” and “search information system” pod, a common drop-down navigation menu with links to all portal functions, a common footer with the page content owner contact information, a feedback link, a page-last-updated date, copyright information, and a page visit counter. Home pages for the various functional areas may contain links to their respective portal functions and documents, and other related sites. Generally, each functional page may have a data selection tab and a results tab.

In one example embodiment, the CPP application is written using ASP (Active Server Pages) running on a Microsoft IIS web server. The data for the CPP is stored in an ORACLE® database. The pages VBScript, Windows Scripting Components, and various ASP objects are executed on the server. In addition, the reading and writing of data from and to the ORACLE® database may be done from the web server. The resulting HTML, JavaScript, and CSS (Cascading Style Sheets) are sent to, and executed by, a browser on a client machine. The HTML, JavaScript, and CSS code is preferably compliant with IE (Internet explorer) 5+, Netscape 6+, and Firefox. It should be understood that these are example tools only, and the common process portal architecture may be markedly different depending upon a variety of factors.

Process asset library 32, or PAL, provides for the storage and retrieval of common processes in the enterprise information system. Preferably, the PAL is a library of information used to store and make available process assets that are potentially useful to those who are defining, implementing, and managing processes within the organization. In certain embodiments, the PAL allows users to search for processes such as Lesson Learned, Best Practices, and other process documents. The processes can be searched for by different reference identifiers such as document ID, document title, document description, and keywords. Documents can also be retrieved based on a search of the document contents. Preferably, the PAL provides users the ability to add new or revised processes into the system.

In one example feature, the PAL provides an on-line matrix so users and managers can track system usage. Preferably, the PAL is provided with the unique capability of uploading an MS Word document directly into the database. The PAL may also allow for the on-line creation of a process document by entering info directly into the database via one or more GUIs, and then generate an MS Word document. The PAL also provides for keyword searching of document content using a single field search (similar to a Google® search). Of course, these are example features only and it will be apparent to one skilled in the art that other similar, related, and/or modified features may be provided.

PAL administrative functions allow users with administrative privileges to perform maintenance on all assets. For example, administrators can review or change the document review frequency. Administrators can also review document release histories. Administrators can add users, and then permit or deny users access to any or all aspects of the system. The administrator function also automatically adds a user with basic permissions the first time they access the system. This function may also allow for the establishment of standard roles (systems engineer, software engineer, hardware engineer, etc.) that may be used to define what type of technical resource is needed to perform a function listed in a PAL document. The administrative function may further allow for the addition/modification/deletion of physical locations (sites) referred to in the deployment product of the system. The administrative function may allow for the maintenance of one or more models (IPDS, CMMI, AS9100) housed within the Common Process Portal, and referenced in the traceability product of the system. “Soft references” may be added through hyperlink to web pages, or other extra-CPP reference locations for documents, models, and other integrated references.

PAL provides subject matter experts (SMEs) the ability to add, update, or delete Best Practice/Lessons Learned reviews for the functions and disciplines to which they are assigned.

PAL also provides a link to an Organizational Measurement Repository. The Organizational Measurement Repository may include one or more databases relating to the following functions: accounting system; financial planning; MA&Q; engineering measures and analysis; information systems; enterprise process team; organizational training; project library; supply chain; human resources; and EVMS (Earned Value Management System) (a process for financial tracking and monitoring of a contract). PAL also provides links to related user manuals and concept of operation documents. Some of the various user functions within the PAL module include: searching for Lessons Learned documents; searching for Best Practice documents; searching for common process assets; searching for all common process documents; searching the content of common process documents for particular key words; adding new common process documents (including Lessons Learned or Best Practices, e.g.); viewing statistical information about the PAL system. Some of the administrative functions provided within the PAL module include: allowing administrators to maintain common process documents; enabling administrators to set a time period for periodic review of particular documents; and enabling administrators to allow users to view various common process asset release reports. An example subject matter expect function is allowing a subject matter expert to add, update, or delete Best Practice documents, Lesson Learned documents, and other common process documents.

Assets within the PAL may be referenced in any number of suitable schemes. In one example, this is accomplished via one or more tables within a configuration management module. The main Configuration Management table is the documents table (“TBL_DOCUMENTS”). Its key is the document ID (“DOC_ID”), but it has a second unique auto generated asset ID (“ASSET_ID”) that is used by several tables. It contains basic information such as document title, type, site, and description, along with information that further defines the document type and use. Internally and externally, the key to this table may be the doc ID, which links the document to various other tables. Internally, the asset ID is also used by several tables and by other applications to link to the documents table.

The documents table contains several foreign keys that link to information in supporting tables. These foreign keys include:
Doc_Type_ID—Links to the document type table (“TBL_DOC_TYPES”) for information about the type of document (Policy, Procedure, Work Instruction, or type of Enabler).
Endorser_ID—Links to the endorser table (“TBL_ENDORSERS”) for information about the PAL-defined group that is responsible for endorsing the document content.
Enterprise_Abbreviation—Links to the enterprise table (“TBL_ENTERPRISES”) for information about the PAL-defined enterprise that the document belongs to.
PS—Abbreviation—Links to the process set table (“TBL_PROCESS_SETS”) for information about the PAL-defined process set that the document belongs to.
Repository_Group_ID Links to the process set table (“TBL_REPOSITORY GROUPS”) for information about the Data Repository (folder or URL) where the document can be found.
Site_ID—Links to sites table (“TBL SITES”) for the site that owns the document.
Sub_Process_Abbreviation—Links to the process set table (“TBL_SUB_PROCESSES”) for information about the PAL-defined process area that the document belongs to.
Owner_Employee_ID—Links to the user table (“TBL_USERS”) for information about the individual who owns the document.
   Several tables contain the document ID (“DOC_ID”) as a foreign key in order to link additional information to the document. These tables include:
TBL_DOC_PROCESS_AREAS—Links from CMMI (or other environment) process areas to the documents that that they map to.
TBL_DOC_REVISIONS—Links from document revision information to the documents that they are revisions of.
TBL_DOC_USER_VISITS—Links from the users with visit counts to the documents that were read or downloaded.
TBL_OE_ENABLERS—Links from the Objective Evidence documents to the Enabler documents that were used to create them.
TBL_PRACTICE_DOCS—Links from the CMMI (or other environment) practices with mapping information to the documents that they map to.
TBL_REQUIREMENTS_DOCS—Links from the CMMI (or other environment) requirements with mapping information to the documents that they map to.
TBL_WI_IOS—Links from the document sections and steps with mapping information to the documents that they use as input or create as output.
   Several tables contain the asset ID (“ASSET_ID”) as a foreign key in order to link additional information to the document. These tables include:
TBL_DISC_AND_FUNC_ASSETS—Links from Functions and Disciplines to the documents that they own, are stakeholders or participants in.
TBL_DOC_BP_LL_FIELDS—Links from Lessons Learned and Best Practice information to their Lessons Learned and Best Practice documents.
TBL_DOC_PAL_FIELDS—Links from PAL information to their documents.
TBL_PAL_DISC_FUNC_ASSETS—Links from the PAL Functions and Disciplines to the documents they map to.

Another Configuration Management table is the document revisions table (“TBL_DOC_REVISIONS”). Its key is the document ID (“DOC_ID”) and document revision ID (“DOC_REVISION_ID”), but it has a second unique auto generated asset revision ID (“ASSET_REV_ID”) that is used by several tables. It contains basic information about changes or revisions to a document like document title, type, site, and description, along with information that further defines the document type and use. Internally and externally, the key to this table is the doc ID and revision ID combination, which links the document revision to other tables. Internally, the asset revision ID is also used by at least one table.

The documents table contains several foreign keys that link to information in supporting tables. These foreign keys include:
Doc_ID—Links to the document table (“TBL_DOCUMENTS”) for information about the document that it is a revision of
Doc_RevisionID—Links to the revisions table (“TBL_REVISIONS”) for information about the revision (initial Dash, A, B, etc.).
Impact_Level—Links to the impact level table (“TBL_REV_IMPACT_LEVELS”) for information about how this revision impacts the programs that use the document.
Imp_Req_Level—Links to the revision implementation requirements table (“TBL_REV_IMP_REQUIREMENTS”) for information about how the programs that use the document need to implement this revision.
Author_Employee_ID—Links to the user table (“TBL_USERS”) for information about the author of the document revision.

A couple of tables contain the document ID (“DOC_ID”) and document revision ID (“DOC_REVISION_ID”) combination as a foreign key in order to link additional information to the document revision. These tables include:
TBL_PROJECT_DOC_DF_REVISIONS—Links from projects to the document revisions that that are currently part of the project tailoring.
One table contains the asset revision ID (“ASSET_REV_ID”) as a foreign key in order to link additional information to the document revision. These tables include:
TBL_DOC_REV_DF_REVIEWERS—Links from Functions and Disciplines with review information to the document revisions that they review.

Another Configuration Management table is the document revision sections table (“TBL_DOC_SECTIONS”). Its key is the document ID (“DOC_ID”), document revision ID (“DOC_REVISION_ID”) and document section name (“DOC_SECTION_NAME”). It contains basic information about sections of the document revisions like section title, description, and header along with tailoring flags.

The sections table contains a foreign key that links to information in its parent table. This foreign key is:
Doc_ID & Doc_Revision_ID—Links to the document revisions table (“TBL_DOC_REVISIONS”) for information about the document revision that contains the section.

A couple of tables contain the document ID (“DOC_ID”), document revision ID (“DOC_REVISION_ID) and document section name (“DOC_SECTION_NAME”) combination as a foreign key in order to link additional information to the document revision section. These tables include:
TBL_DOC_SECTION_CONTENT—Links document sections that that contain them.
TBL_DOC_SECTION_STEPS—Links from sections that that contain them.

Another Configuration Management table is the document revision section steps table (“TBL_DOC_SECTION_STEPS”). Its key is the document ID (“DOC_ID”), document revision ID (“DOC_REVISION_ID”), document section name (“DOC_SECTION_NAME”) and step number (“DOC_STEP_NUM”), but it has a second unique auto generated document revision section step ID (“DOC_SECTION_STEP_ID”) that is used by several tables. It contains basic information about the steps like step description, roles and comments. Internally, the document revision section step ID is used by several tables. Externally, the key to this table is the doc ID, revision ID, section name and step number combination.

The sections table contains a foreign key that links to information in its parent table. This foreign key is:
Doc_ID, Doc_Revision_ID & Doc_Section_Name—Links to the document revision sections table (“TBL_DOC_SECTIONS”) for information about the document revision section that contains the step.

Several tables contain the document revision section step ID (“WI_TASK_STEP_ID” or “DOC_SECTION_STEP_ID”) as a foreign key in order to link additional information to the document revision section step. These tables include:
TBL_DOC_CHARACTER_CHOICES—Links from characteristic choices with pre-tailoring information to the document revision, section or step that it tailors.
TBL_DOC_SECTION STEP CONTENT—Links from step contents to the document revision section step that that contains it.
TBL_PROJECT_DOC_TAILORINGS—Links from project with tailoring information to the document revision, section or step that was tailored.
TBL_WI_IOS—Links from document with input or output information to the document_revision, section or step that uses it as input or generates it as output.
TBL_WI_TASK_STEP_IPDS_MAPPINGS—Links from various process elements with mapping information to the document revision, section or step that it applies to.
TBL_WI_TASK_STEP_ROLES—Links from roles to the document revision, section or step that that role performs.

Another Configuration Management table is the characteristics table (“TBL_CHARACTERISTICS”). Its key is the auto generated characteristic ID (“CHARACTERISTIC_ID”). It contains information about the characteristic like its label (question), type, and activation and deactivation dates. Internally, the characteristic ID is used by several tables. Externally, the key to this table is a formatted version of the function/discipline acronym and the characteristic number.

The characteristics table contains foreign keys that link to information in supporting tables. These foreign keys include:
Disc_Func_Acronym—Links to the Function and Discipline table (“TBL_DISCIPLINES_AND_FUNCTIONS”) for the Function or Discipline that the characteristic belongs.
Last_Updated Employee_ID—Links to the user table (“TBL_USERS”) for the user information for the individual who last updated the characteristic.
One table contains the characteristic ID as a foreign key in order to link additional information to the characteristic. This table is:
TBL_CHARACTER_CHOICES—Links from characteristic choice (answer) information to the characteristic.

Another Configuration Management table is the characteristic choices table (“TBL_CHARACTER_CHOICES”). Its key is a combination of the characteristic ID (“CHARACTERISTIC_ID”) and choice ID (“CHARACTER_CHOICE_ID”). It contains information about the choice (possible answer to the characteristic question).

The characteristics table contains a foreign key that link to information in a supporting table. This foreign key is:
Characteristic_ID—Links to the Characteristics table (“TBL_CHARACTERISTICS”) for the characteristic that the choice belongs.
One table contains the characteristic ID as a foreign key in order to link additional information to the characteristic. This table is:
TBL_DOC_CHARACTER_CHOICES—Links from document revision, section and step information with pre-tailoring information to the characteristic choices (answers).

TBL_PROJ_CHARACTER_CHOICES—Links from project to the choices (answers) make for the characteristic questions.

Integration and traceability module 33 preferably provides coordination among documents within the common process portal, and traceability between the portal documentation (which may reside, for example, in the PAL) and systems which may be internal or external to the portal. As with all other modules, the integration and traceability module may be split into two or more modules or sub-modules, depending on such factors as architecture and software development preferences. Integration refers to defining relationships between documents within the common process portal. For instance, in one embodiment, documents within the process asset library are tied to each other by way of one or more reference identifiers. Reference identifiers may include any suitable reference data such as document title, document identification number, version number, model number, document owner, enterprise division, and so forth. Any suitable piece of information can be used as a reference identifier as long as it distinguishes one associated document (or other corresponding piece of data) from another document. Traceability refers to the defining of relationships between documents within the portal, and systems internal or external to the portal. The external systems may be additional systems within the enterprise or may be systems external to the enterprise itself. The internal systems may be a representation of a specific version of interest of external systems. The internal systems may also be a representation of a specific version of interest of an enterprise system. Thus, the traceability function provides a link between portal information elements and systems, which may be (for example) internal portal systems, enterprise systems that are external to the portal, or systems that are external to the enterprise.

Deployment module 34 enables and coordinates the use of common process assets by various enterprise programs. For example, an enterprise project may be added to the deployment tool along with its relevant information. Then, the common process documents may be tailored, using the common process portal, based on the type and size of the project. Among other functions, the process deployment module handles the creation and maintenance of project information. One example method by which this is accomplished is as follows.

Process Deployment processing may center around creating and maintaining project information. The following is the basic process flow using the project maintenance screens:
1. Create a new project with the appropriate information. Project name and acronym are unique.
2. Update the project administration data as necessary.
3. Add the names of the approvers for the Function/Discipline Asset Tailoring.
4. Add the names of the individuals who fill the mandatory project roles, add additional roles and names as necessary, and grant project update access to the appropriate individuals. Note: Individuals filling project roles will automatically be granted read access to the project information.
5. Answer the Function/Discipline characteristic questions on the project questionnaire. Alternatively, the copy function can be used to copy characteristic choices from a similar existing project.
6. Perform Information Processing tailoring. Alternatively, the copy function can be used to copy Information Processing tailoring from a similar existing project or import from a spreadsheet.
7. Perform Asset tailoring for each Function/Discipline. Alternatively, the copy function can be used to copy Information Processing tailoring from a similar existing project or import from a spreadsheet.
   a. Apply Information Processing tailoring as the first step in pre-tailoring the asset tailoring.
   b. Apply Characteristics as the next step in pre-tailoring the asset tailoring. The Display Applicable Characteristics option can be used to see how which characteristics apply.
   c. Finish the asset tailoring.
8. Send emails to approvers to review and approve the appropriate Information Processing and Asset tailoring.
9. Each approver reviews and approves the appropriate tailoring through the use of an electronic signature capability. Author's note: This electronic signature capability may tie into an enterprise secure server authorization system (i.e., an enterprise password authorization system) and allow for secure approval capability. Unless a password is compromised, only the approver can provide an electronic signature. This electronic signature capability is also used throughout the CPP where approvals are requested. This eliminates paper chasing of hard copy of documents from person to person, and from site to site expediting the approval process of documents and tailoring.
10. Send email to Project Manager to get overall tailoring approval.
11. Project Manager reviews and approves the tailoring.
12. Generate an approved tailoring spreadsheet and store with the project's other objective evidence.
13. Maintain project information as appropriate during the programs lifecycle.

The Characteristics Report is actually part of CM and is documented there. The link from Process Deployment is provided as a convenience.

The Delinquent Approval Reports page is used to search for projects who's Tailoring Approvers have not yet provided their approval for a given function/discipline. The following is the basic process for running a Delinquent Approval Report.
1. Select the Site to run the report for.
2. Select the Project(s) to search for, or search on ‘All Projects’.
3. Select the Results per Page to display.
4. Press the ‘Select’ button to view the report results or click ‘Clear’ to reset the search criteria and start again.

The Information Processing Maintenance page is used to maintain Information Processing Elements and their links to the Common Process assets. The Information Processing versions come from Raytheon Corporate and are loaded via separate scripts. This page is used to make corrections, to add Information Services extensions, and to add the links to assets. The following is the basic process for adding an Information Services extension to the Information Processing Elements.
1. Create a new Processing Element. All fields are required and the extension should be marked as yes for an appropriate extension.
2. List the Asset Mapping and add new assets mapping as needed.
   a. Bring up a list of the assets to select from.
   b. Select the appropriate asset.
   c. Select the appropriate revision, section and step.

The Default Tailoring Approval Authority Maintenance page is an administrative page used to assign default tailoring approvers to product lines and project sites. The page can be used to clear all default approvers or load default approvers via scripts based on the appropriate governing document—these features will only be available to users with a special “Load/Clear Default Approvers” permission available via User Maintenance. These Load/Clear options will be available under the Show/Hide instructions feature on the page. To assign default approvers to a product line/project site area, choose the product line and project site in the pull down menus. Clicking “Edit Default Approvers” will bring up the approvers list, which are pull down menus where you can choose an employee. The ‘+’ button to the right of the pull down allows the user to search for approver by employee ID.

The site feedback management module 35 provides, among other things, a concise place for a user to express concern regarding the function or feature of the Common Process Portal (CPP). This feedback mechanism automatically captures the user, the page within the CPP on which they clicked the feedback button, classification of the type of feedback (urgent, routine, informational), a forum for discussing what constitutes their concern, and a built-in email response system. As the feedback is processed, the submitter is provided incremental informative email responses until the feedback is closed.

The Configuration Management module 36 provides for the creation and update of common process assets and project characteristics. The Configuration Management module also controls updates to functions and disciplines within the information system. A change control board may be provided to approve new and revised assets, which may be added to the common process portal and then released for use. The change control board may also approve new and revised characteristics, which may be added to the common process portal. Preferably, the Configuration Management module is linked to other software modules for providing asset maintenance, characteristics maintenance, characteristics upload, functions/discipline maintenance, common process element time stamp maintenance, bulk asset information padding, and various reporting functions.

In one example, Configuration Management processing is centered on the creation and maintenance of Common Process Element information. The following is the basic process flow using the Asset Maintenance, CPE Release Reports and Bulk Asset Add screens.
1. Create a new asset with the appropriate information. The Document ID is unique and conforms to the proper naming standards. If the document is expected to have revisions, the “Has Revisions” question must be answered as Yes.
2. If the asset has revision, add the information about the initial revision (dash version).
3. Update the asset IT (Integration/Traceability), PDM (Project Deployment), and PAL (Process Asset Library) data as necessary.
4. Update the Asset PIM (Process Integration Matrix) data to show which Functions and Disciplines are Owners, Stakeholders and Participants in the Common Process Document.
5. Generate the PAL release report spreadsheet for the assets that have been approved for release.
6. Send the generated spreadsheet to PAL along with a zip file containing the documents.
7. Update the returned PAL spreadsheet that contains the PAL Asset IDs with release dates and any other relevant information, and then upload the information into the CPP (Common Process Portal).
8. Ingest the section and step contents of the document revision into the CPP.
9. Update Section, Step, Document Type, and Role information as necessary.

The Characteristics Maintenance page is used to add and update project characteristic questions and choices, and to link them to the appropriate documents, revisions, sections and step with the appropriate tailoring element. The following is the basic process flow using the Characteristic Maintenance, Report and Upload screens.
1. Create a new characteristic for the appropriate Function/Discipline. Specify whether it is a Yes/No or Multiple Choice question and add the appropriate choices. The activation and deactivation dates will determine for which document revisions the characteristic is available.
2. Use the sorting function to move the new characteristic to the correct sorting location for display on the Project Questionnaire.
3. For major changes, update the correct document revisions with the characteristic tailoring elements using the Characteristic Report and Upload Screens.
   a. Generate a characteristics Excel spreadsheet for the appropriate Function and Discipline, and with the needed document, revision, section, and step information.
   b. Add or update the tailoring elements for the appropriate combination of document and characteristic choices.
   c. Add or update tailoring comments as appropriate.
   d. Upload the spreadsheet into the CPP.
4. For minor changes, update the correct document revisions with the characteristic tailoring elements using the Characteristic Maintenance Screens.
   a. Show the correct Sections and Steps.
   b. For each section and step, show the correct characteristics.
   c. For each characteristic choice, add the correct tailoring element.
   d. Add or update tailoring comments as appropriate.

The Function/Discipline Maintenance page is used to maintain information about the Functions and Disciplines. The following is the basic process flow using the Function/Discipline Maintenance screens.
1. Select the Display Info option for the appropriate Function/Discipline and update the information as necessary.
2. Select the Display POC (Points of Contact) option List for the appropriate Function/Discipline and add or update the information about the individuals who are the Points of Contact for the Function/Discipline.

The Common Process Element (CPE) Timestamp Maintenance page is used to maintain the number of days that a revision should be flagged as new, updated or deleted on the PAL Elements page.

The change request management module 37 provides, among other things, a mechanism for users to requests changes to data housed within the system, such as documents. The change request module differs from the feedback module in that the feedback generally refers to site feedback (e.g., regarding web pages) where the change request deals with feedback about documents (i.e., CPEs or common process elements) that are found on the web pages. The change request system ties into the database housing the documents, identifies the particular document reference identifier, and provides a forum for the user to provide reference information about the document and what requests for modification are being made. This allows for tracking the request to closure.

The evidence collection and compliance module 38 provides, among other things, the capability to organize evidence by one of a plurality of process areas. The tool provides the capability to specify parameters for each item of evidence (either direct evidence or indirect evidence). The tool also allows for user access control. Based on permissions, some users will not have access to some of the features. The tool preferably has a report capability to allow for individual use, or through report selection, export in a form directly usable by the third-party information management system.

On one level, the common process portal enables seamless management of information by housing the information, automatically referencing the information with respect to one or more applications, and automatically exporting the information to the one or more applications. Preferably, all of these functions are achieved from a single, common application without the need for replicating and/or migrating the information from one application to another. The system may employ a process access mechanism which may be embodied as a database for housing the information. The information may be associated with one or more reference identifiers and/or access points that enable the information to be automatically shared among one or more of the various modules or applications previously described.

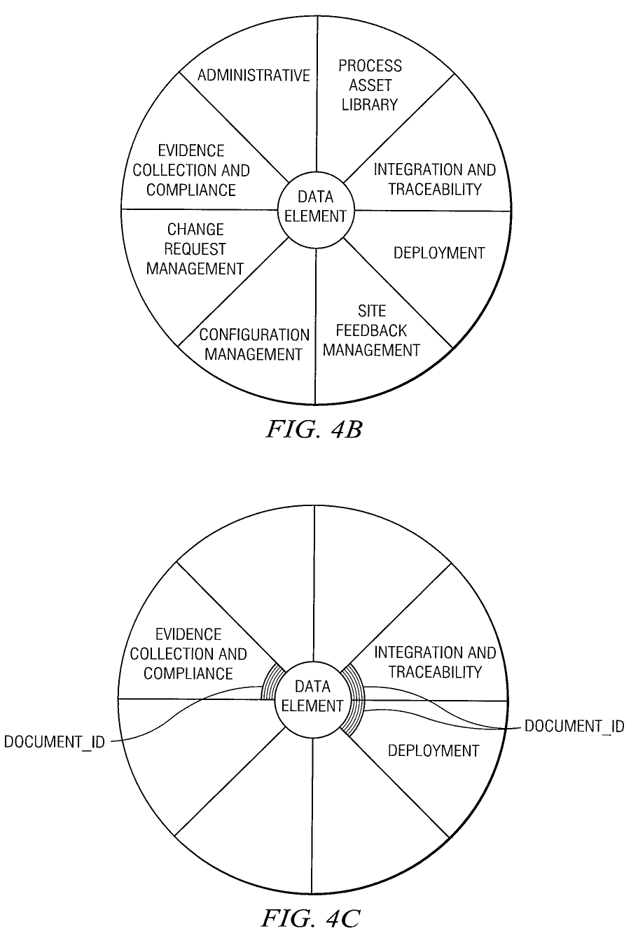

A conceptual diagram of the sharing feature is provided in FIGS. 4A-4C. FIG. 4A illustrates a pie diagram having eight sections representative of the eight modules previously described. FIG. 4B illustrates a hub representative of one or more data elements corresponding to one or more pieces of data housed within the common process portal (for example, stored within the PAL). The one or more data elements in the hub may be designated with any of the various reference identifiers previously described. These reference identifiers provide the basis for the integration and traceability functions previously described. FIG. 4C illustrates the concept that the one or more reference identifiers for a particular document may be intentionally provided to establish support for a subset of the modules. Thus, for the particular document referenced in connection with FIG. 4C, a reference identifier, such as a document ID, for example, may enable seamless access of the document by the integration and traceability module, the evidence collection and compliance module, and the deployment module. The particular document would not be automatically supported by, or exported to, the other modules of the portal. Of course, any particular document, via its reference identifiers or other data elements, may be made automatically and seamless accessible by all, some, one, or none of any of the particular modules of the common process portal.

According to another embodiment of the present invention, software is provided which, when executed by one or more processors, for example, achieves one or more of the various functionalities described herein. Preferably, the software is provided in one or more modules corresponding to the various common process portal modules previously described.

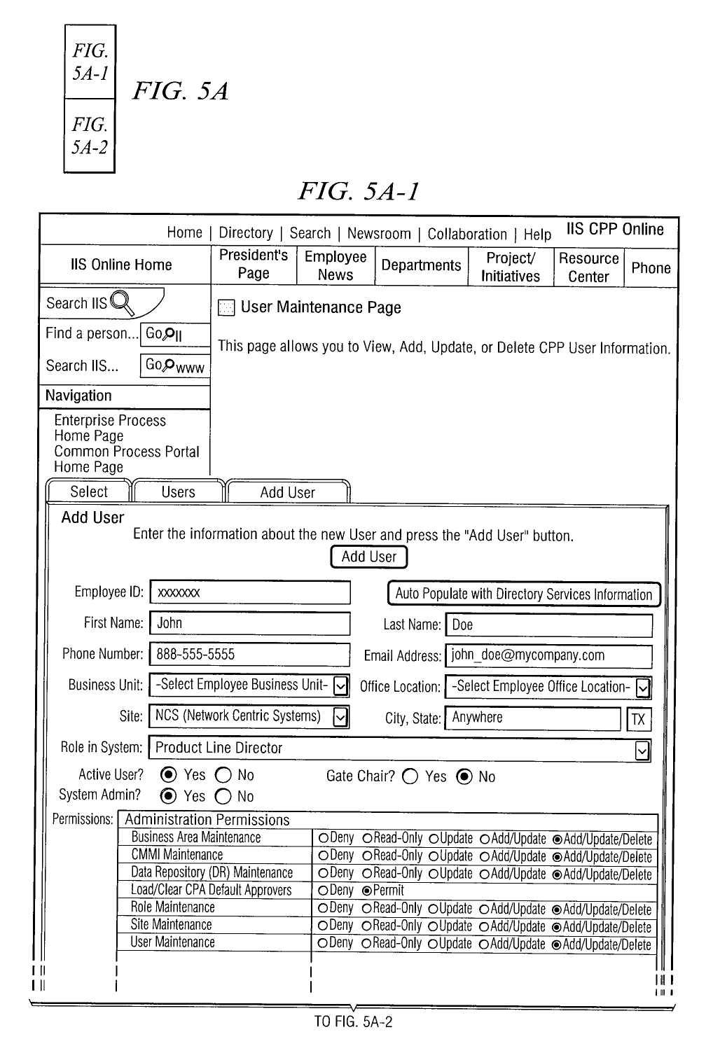

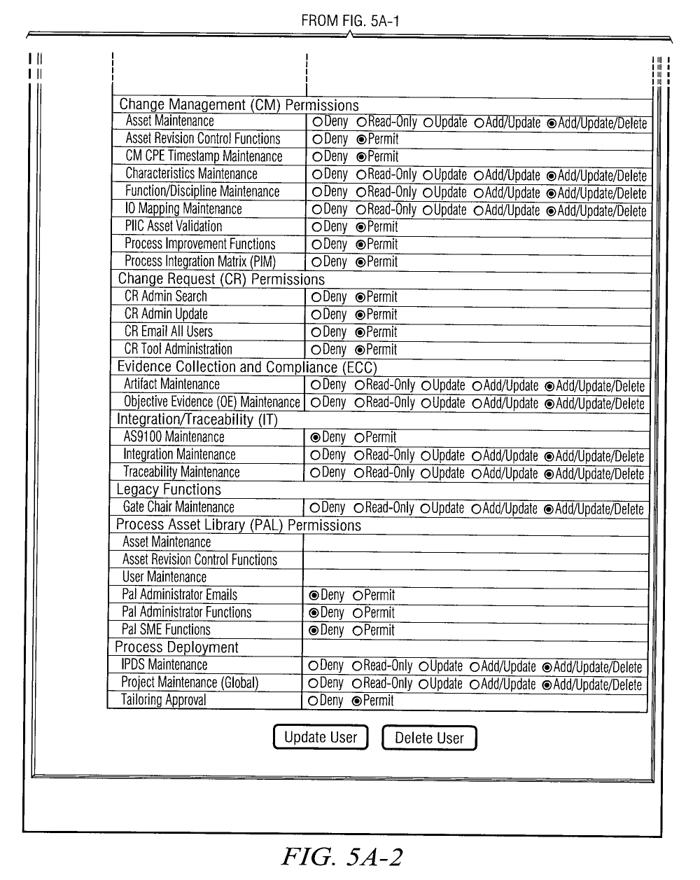

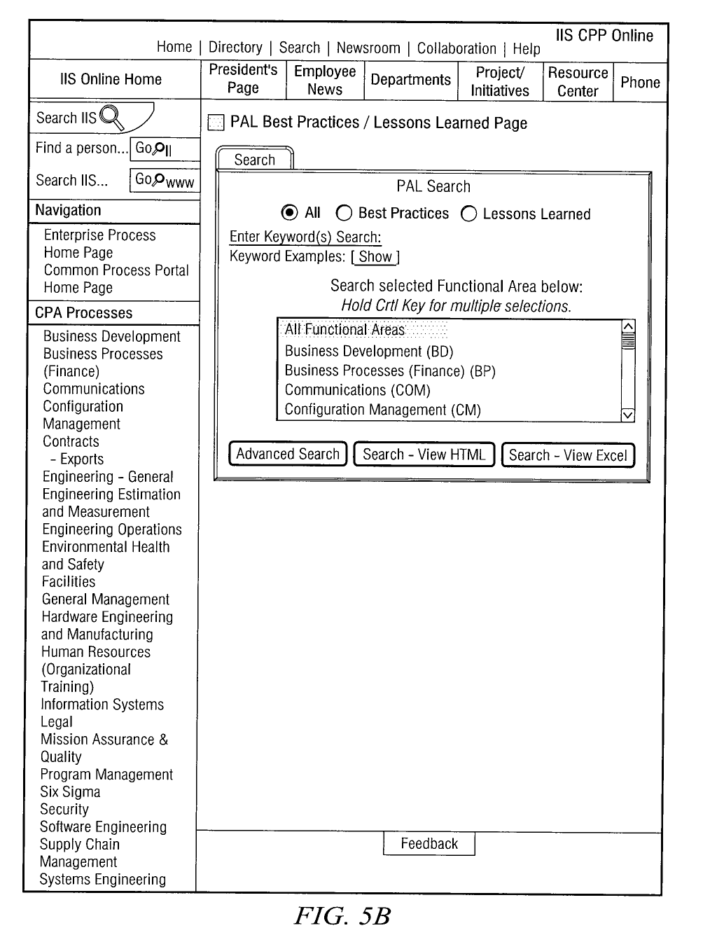

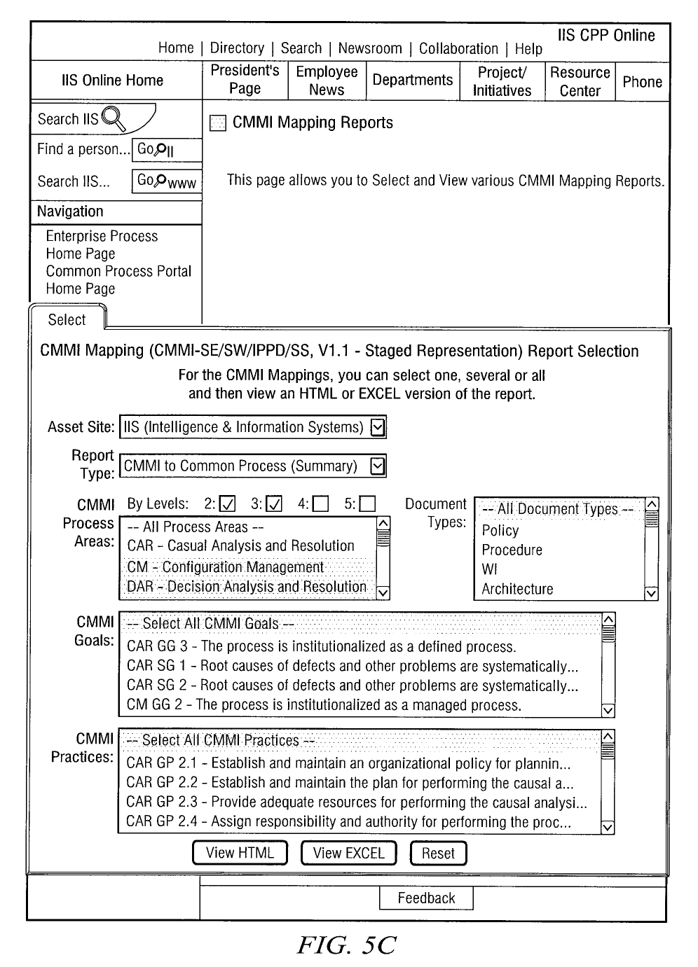

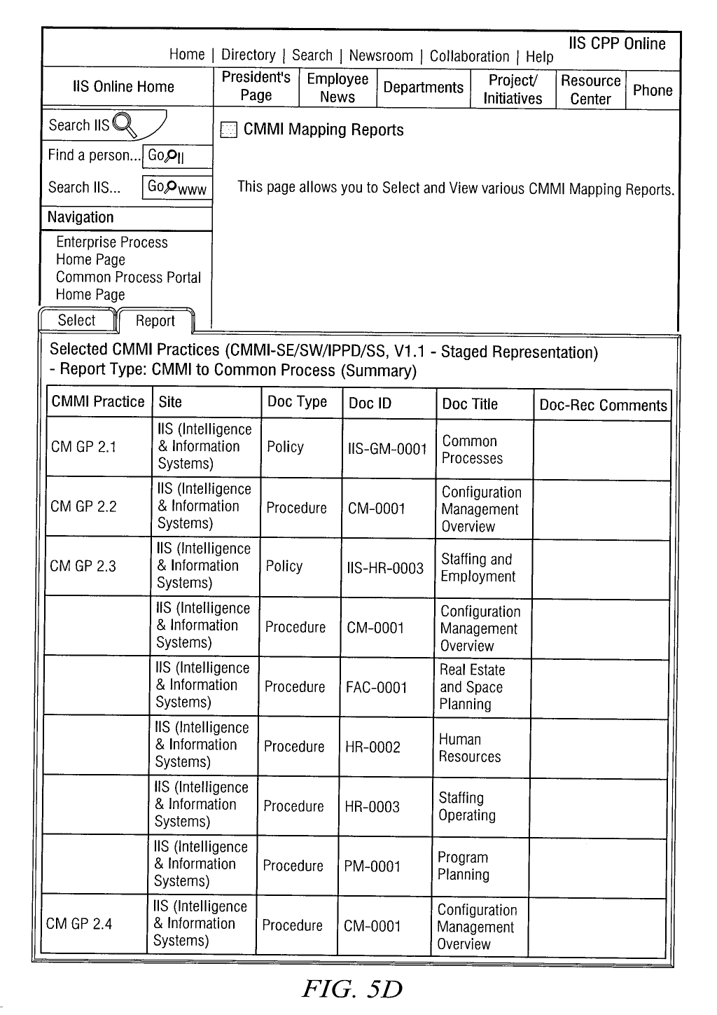

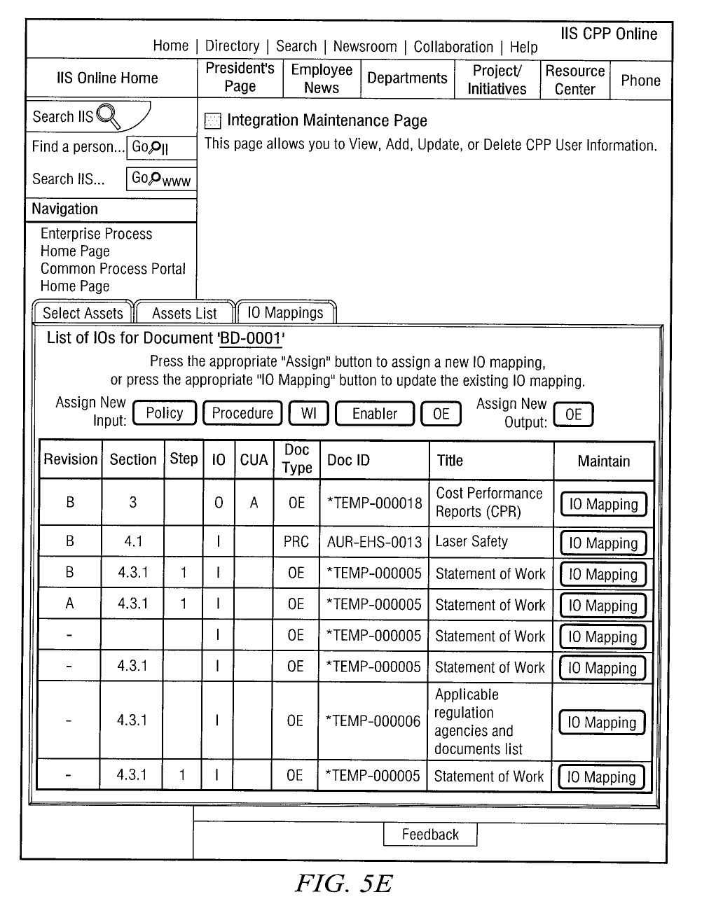

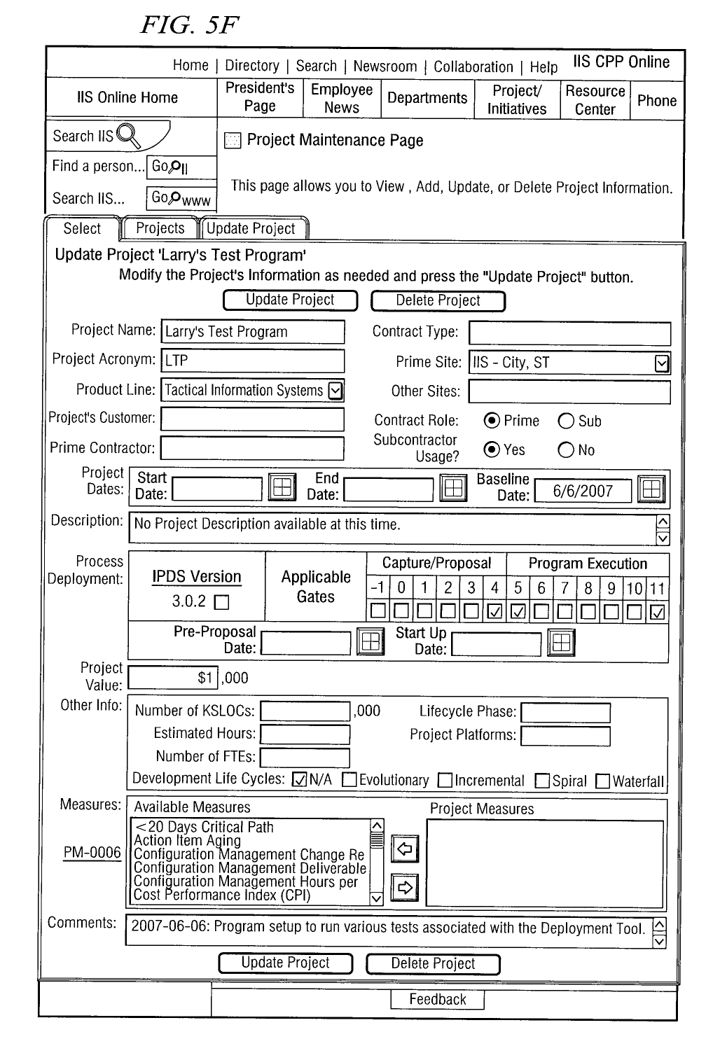

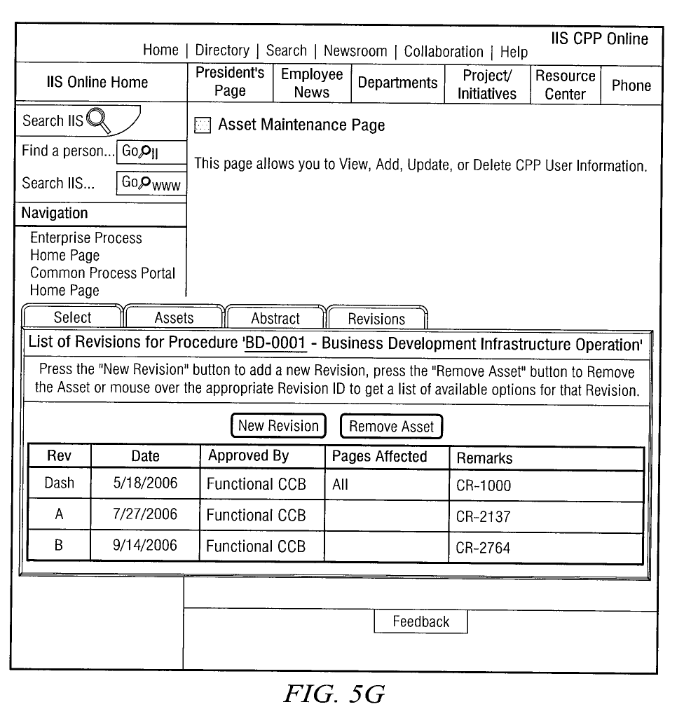

According to another embodiment of the invention, one or more graphical user interface (GUI) are provided to enable a user to achieve the various functionalities described herein. Examples of the graphical user interfaces are provided in FIGS. 5A through 5G. FIG. 5A, for example, illustrates a GUI for administrative and maintenance functions. FIG. 5B, for example, illustrates a GUI for a PAL searching function. FIGS. 5C and 5D, for example, illustrate a GUI for a traceability function. The specific example traceability function illustrated is traceability from Common Process Elements to CMMI®. FIG. 5E, for example, illustrates a GUI for integration from one Common Process Element to another. FIG. 5F, for example, illustrates a Deployment/Project Information Record function. FIG. 5G, for example, illustrates a GUI for a Configuration Management/Asset Revision function. Any of the various functionalities described herein, particularly involving interaction between the system and one or more users, may be provided in a GUI format. The invention has been shown in several embodiments. It should be apparent to those skilled in the art that the invention is not limited to these embodiments, but is capable of being varied and modified without departing from the scope and spirit of the described example embodiments.

What is claimed is:

1. A system for managing a plurality of information elements, comprising:
at least one processor operable to execute a plurality of software modules; and
at least one data storage device coupled to the at least one processor, the at least one data storage device operable to store data and transfer data to and from the at least one processor;
wherein the plurality of software modules comprises a plurality of application modules operable to process the information elements; and
a common module in communication with the plurality of application modules, the common module comprising:
an information storage component for effecting storage of the information elements; and
a referencing component operable to automatically associate each of the information elements with one or more selected application modules.

2. The system of claim 1, wherein the common module further comprises an export component operable to automatically export each of the information elements to its one or more associated application modules.

3. The system of claim 1, wherein the common module comprises a web-based process portal.

4. The system of claim 1, wherein the common module and the application modules collectively comprise a web-based process portal.

5. The system of claim 1, wherein the plurality of application modules comprises a process asset library operable to store at least some of the plurality of information elements; and an integration module operable to associate at least one of the information elements with at least one other information element.

6. The system of claim 1, wherein the plurality of application modules comprises a traceability module operable to associate at least one of the information elements with at least one application external to the system.

7. The system of claim 1, wherein the plurality of application modules comprises an evidence collection and compliance module operable to collect indicia for assessing compliance with a process, and further operable to format the indicia for use in a plurality of process management systems.

8. A computer program product in a computer readable media for use in a system for managing a plurality of information elements, the computer program product comprising:
a plurality of application modules operable to process the information elements; and
a common module in communication with the plurality of application modules, the common module comprising:
an information storage component for effecting storage of the information elements; and
a referencing component operable to automatically associate each of the information elements with one or more selected application modules.

9. The system of claim 8, wherein the common module further comprises an export component operable to automatically export each of the information elements to its one or more associated application modules.

10. The system of claim 8, wherein the common module comprises a web-based process portal.

11. The system of claim 8, wherein the common module and the application modules collectively comprise a web-based process portal.

12. The system of claim 8, wherein the plurality of application modules comprises a process asset library operable to store at least some of the plurality of information elements; and an integration module operable to associate at least one of the information elements with at least one other information element.

13. The system of claim 8, wherein the plurality of application modules comprises a traceability module operable to associate at least one of the information elements with at least one application external to the system.

14. The system of claim 8, wherein the plurality of application modules comprises an evidence collection and compliance module operable to collect indicia for assessing compliance with a process, and further operable to format the indicia for use in a plurality of process management systems.

15. A graphical user interface for use in a system for managing information, the graphical user interface comprising:
at least one window representing a common module for enabling a user to interact with a plurality of application modules to manage a plurality of information elements;
wherein the plurality of application modules are operable to process the information elements; and
wherein the common module in communication with the plurality of application modules, the common module comprising:
an information storage component for effecting storage of the information elements; and
a referencing component operable to automatically associate each of the information elements with one or more selected application modules.

16. The graphical user interface of claim 15, wherein the common module further comprises an export component operable to automatically export each of the information elements to its one or more associated application modules.

17. The graphical user interface of claim 15, wherein the plurality of application modules comprises a process asset library operable to store at least some of the plurality of information elements; and an integration module operable to associate at least one of the information elements with at least one other information element.

18. The graphical user interface of claim 15, wherein the plurality of application modules comprises a traceability module operable to associate at least one of the information elements with at least one application external to the system.

19. The graphical user interface of claim 15, wherein the plurality of application modules comprises an evidence collection and compliance module operable to collect indicia for assessing compliance with a process, and further operable to format the indicia for use in a plurality of process management systems.
